(19) United States
(12) Patent Application Publication
(10) Pub. No.: US 2022/0161077 A1
(43) Pub. Date: May 26, 2022

(54) MOTOR VEHICLE WITH OPTIMIZED ACCESSIBILITY FOR EXTINGUISHING A BATTERY FIRE

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/533,594

(22) Filed: Nov. 23, 2021

(30) Foreign Application Priority Data
Nov. 24, 2020 (DE) 102020131109.5

(51) Int. Cl. A62C 3/16; B60K 1/04; A62C 3/07; H01M 50/249

(52) U.S. Cl. CPC A62C 3/16; B60K 1/04; H01M 2220/20; H01M 50/249; B60K 2001/0438; A62C 3/07

(57) ABSTRACT

A motor vehicle having an access area for extinguishing a battery fire. The motor vehicle includes a high voltage battery with a battery housing and at least one battery cell, a receiving area in which the high voltage battery is received, a side wall which bounds the receiving area in one direction, and an access area which is positioned in the side wall and through which an extinguishing device can be introduced at least partially into the receiving area from a side of the side wall facing away from the high-voltage battery. The receiving area has at least one defined dead area associated with the access area, in which no battery cell is arranged.

### FIELD

The invention relates to a motor vehicle with an access area for extinguishing a battery fire, wherein the motor vehicle comprises a high-voltage battery which has a battery housing and at least one battery module arranged in the battery housing with at least one battery cell, and a receiving area in which the high-voltage battery is received. Furthermore, the motor vehicle has a side wall which delimits the receiving area in at least one direction, and the access area which is positioned in the side wall and which is designed such that an extinguishing device, in particular an extinguishing lance, can be inserted at least partially into the receiving area through the access area from a side of the side wall facing away from the high-voltage battery.

### BACKGROUND

The present invention is in the field of high-voltage batteries, particularly for operating motor vehicles, for example electric and/or hybrid vehicles. In such high-voltage batteries, thermal propagation can occur under certain circumstances, for example in the event of an accident. Such a thermal runaway of battery cells initially manifests itself in an increasing temperature of these battery cells, which then usually burst into flames or explode without countermeasures. According to the current state of the art, such a battery fire can be extinguished by the firefighters using a so-called extinguishing lance. Typically, such an extinguishing lance is shot from above through the vehicle floor into the battery and floods it.

In this context, DE 10 2018 222 429 A1, for example, describes an electrically operated vehicle with a traction battery arranged underneath the vehicle floor, wherein in a floor panel part forming the vehicle floor at least one extinguishing lance access is formed, through which an extinguishing lance can be driven from the top of the vehicle to the bottom of the vehicle into the battery interior when the traction battery is damaged, in order to flood the battery interior with extinguishing agent. An extinguishing lance template is provided which, in the event of an accident, can be positioned correctly on the floor covering of the vehicle in order to detect the position of the visually protected extinguishing lance access located underneath the floor covering.

Furthermore, DE 10 2016 224 473 A1 describes a system for a vehicle with an outer wall that has an opening with a closure element. The opening is accessible from the outside, wherein an extinguishing liquid can be filled through the opened opening into an interior space enclosed by the outer wall, in which an energy storage device is located. Extinguishing a burning high-voltage battery using an extinguishing lance involves various risks. First, firefighters must be specially trained to use such an extinguishing lance. Nevertheless, mistakes still happen frequently today when extinguishing with an extinguishing lance. In particular, the greatest danger in this case is when high-voltage voltage reaches the car body. Also the accessibility to be able to insert such an extinguishing lance at appropriate access areas can still be optimized.

### SUMMARY

The object of the present invention is therefore to provide a motor vehicle which enables to provide an access area for extinguishing a battery fire in the safest possible manner. A motor vehicle according to the invention with an access area for extinguishing a battery fire has a high-voltage battery, which has a battery housing and at least one battery module arranged in the battery housing with at least one battery cell, as well as a receiving area in which the high-voltage battery is received. Furthermore, the motor vehicle has a side wall which delimits the receiving area in at least one direction, and the access area which is positioned in the side wall and which is designed such that an extinguishing device, in particular an extinguishing lance, can be inserted at least partially into the receiving area through the access area from a side of the side wall facing away from the high-voltage battery. In this case, the receiving area has at least one defined dead area which is associated with the access area and is free of battery cells, wherein the at least one battery cell is arranged in a region of the receiving area which is different from the dead area, and wherein the access area is positioned and designed in such a way that an extinguishing device which is passed at least in part through the access area can be inserted exclusively into the associated dead area.

The dead area is thus defined in such a way that the at least one battery cell is not located in this dead area, in particular no battery cell of the high-voltage battery, at least if the high-voltage battery and the side wall are not deformed and the high-voltage battery is located in its intended position in the receiving area. In other words, the definition of the dead area arrangement refers to an initial state of the high-voltage battery arrangement in the recording area. Furthermore, the dead area does not have to be provided subjectively, but can also merely define a spatial area in which at least no battery cell is arranged, for example a free spatial area. That is, the dead area generally represents a spatial area free of battery cells of the receiving area. Thus, if an extinguishing device, such as an extinguishing lance, is inserted into the receiving area through an access area positioned and designed according to the invention, it is ensured that such an extinguishing lance will not pierce or otherwise damage a battery cell. This significantly reduces the risks associated with the insertion of an extinguishing lance by rescue personnel, and also minimizes the likelihood of high-voltage voltage coming into contact with the car body. Especially if the battery fire is not yet far advanced, the probability that still intact battery cells will also suffer thermal runaway or explode due to damage by the extinguishing lance can be significantly reduced. Since a high-voltage battery in a motor vehicle is usually located in a specially protected area that is additionally protected by crash structures, there is also little likelihood of any significant displacement between the access area and the associated dead area in the event of an accident, so that even in the event of damage to the motor vehicle, it is still ensured in all probability that no additional damage to a battery cell occurs when an extinguishing lance is inserted through the access area.

Possible configurations of the access area, by which it can be managed that the extinguishing lance can only be inserted into the space free of battery cells, namely the dead area, will be described in more detail later. To give some examples, the access area can be designed as an opening with a funnel-shaped guide element tapering in the direction of the receiving area, which guides the extinguishing lance specifically when it is inserted into this dead area. In this example, the dead area comprises the spatial area that adjoins the funnel-shaped guide element in the insertion direction. However, the access area could also simply be designed as a sufficiently narrow opening so that the extinguishing lance has little play during insertion, in particular so that the play of the part of the extinguishing lance passing through the opening is limited to the dead area. In this example, the dead area includes the spatial area adjacent to the opening in the direction of insertion.

Preferably, the high-voltage battery is thereby formed with a plurality of battery modules, wherein each of these plurality of battery modules in turn preferably have a plurality of battery cells, such as lithium-ion cells. In the context of the present invention, an extinguishing device is preferably understood to mean an extinguishing lance or similar elongated, tubular or pipe-like extinguishing device. An extinguishing lance is an extinguishing tool or device commonly used by firefighters to extinguish high-voltage battery fires. Such an extinguishing device is usually designed as a standardized steel pipe. Typically, such an extinguishing lance has a tip and includes holes in the pipe through which an extinguishing agent, usually water, can escape.

The access area can be designed in various ways. For example, this can be provided by an opening, in particular a closable or closed opening, as a kind of predetermined breaking point, material weakening or the like. Particularly advantageous embodiments of such an access area are explained in more detail later. Furthermore, it may be provided that the motor vehicle has not only one such access area, but several. Such multiple access areas do not necessarily have to be positioned in the same side wall, but can also be located in different side walls adjacent to the receiving area. The provision of several such access areas has the great advantage that the probability of at least one of these access areas being accessible by the firefighters by means of the extinguishing lance can thereby be increased.

Furthermore, it is preferred that the motor vehicle has a motor vehicle floor adjacent to the receiving area, wherein the high-voltage battery is arranged below the motor vehicle floor and at a distance from the motor vehicle floor, so that there is an intermediate space between the high-voltage battery and the vehicle floor. The term “below” as well as other directional indications used in the following, such as “above”, “below”, “over” and “beneath” or similar, refer to the direction of gravity in a motor vehicle, which is aligned with its vehicle vertical axis parallel to the direction of gravity, so that a vehicle vertical axis pointing from the vehicle floor in the direction of the vehicle roof is opposed to gravity. In this area, i.e. below the vehicle floor, there is plenty of space available to accommodate numerous battery modules. In addition, these battery modules or the high-voltage battery as a whole can be protected by vehicle side sills with integrated crash structures.

Thereby, according to an advantageous embodiment of the invention, it is provided that the access area is positioned and designed in such a way that an extinguishing device, in particular an extinguishing lance, which passes through the access area at least in part, opens into the intermediate space, wherein the dead area is arranged completely outside the battery housing. This allows the intermediate space between the high-voltage battery and the vehicle floor to be extinguished or cooled with extinguishing water. This, in turn, has the great advantage that it can also be used to cool the vehicle floor. This, in turn, is based on the knowledge that the main reason why personal injuries result from a battery fire is that the temperature very quickly jumps to the vehicle floor during a battery fire, and then the carpets that are usually placed on the vehicle floor in the passenger compartment are set on fire. This advantageous design means that the air gap between the vehicle underbody and the high-voltage battery can be flooded in the event of an accident, i.e. in the event of a burgeoning battery fire, whereby the vehicle underbody, called vehicle floor for short, can be advantageously cooled, whereby excessive heating of the vehicle floor can be avoided or at least delayed in time, whereby additional rescue minutes can be created for occupants. The fact that the dead area in this case is completely outside the battery housing, i.e. the extinguishing device, in particular an extinguishing lance, cannot even penetrate the battery housing when passing through the access area, can also advantageously ensure that the extinguishing lance cannot even come into contact with the battery cells. This makes the extinguishing process particularly safe. For example, if the high-voltage battery or the battery housing is located in the direction of insertion of the extinguishing lance, and the extinguishing lance is to be prevented from piercing the battery housing and thus penetrating the battery, the battery housing as a whole or at least in a region located behind the access area in this direction of insertion can be of correspondingly robust design so that penetration of the housing in this region by the extinguishing lance is prevented. Nevertheless, it is still possible to provide the access area in such a way that it is also possible to penetrate the battery. Accordingly, it is a further advantageous embodiment of the invention if the dead area is arranged at least partially within the battery housing. This has the great advantage that the high-voltage battery housing can then be flooded and not just flushed with extinguishing water. This allows a very good extinguishing of the fire. However, even in this case, suitable positioning and design of the access area can ensure that the extinguishing lance enters a dead area, i.e. an area within the high-voltage battery or its housing in which no battery cell is located. It is particularly advantageous to provide such dead areas in the vicinity of a side wall of the high-voltage battery, which is different from a bottom of the high-voltage battery. This is due to the fact that battery modules are usually arranged directly on a housing base, through which, for example, cooling of the battery modules is also provided during normal operation. Between the top of the battery modules and a housing cover, on the other hand, there is space suitable for inserting an extinguishing lance. There is also usually space in side areas, i.e. near the side walls of the battery housing, which are located between the housing cover and the housing base, in which no battery cells are located and which is therefore suitable for the insertion of an extinguishing lance. Also, for example, a dead area may be positioned such that it is located between two battery modules. For example, defined free areas can also be provided in the high-voltage battery within the battery housing to allow safe penetration of the extinguishing lance in these areas, which then correspondingly represent dead areas. This allows safe penetration of an extinguishing lance to be combined with particularly effective extinguishing of the high-voltage battery. In another advantageous embodiment of the invention, the sidewall constitutes at least a portion of the vehicle floor of the motor vehicle. For example, the access area can be located in the interior of the motor vehicle under a carpet, which has the advantage that this access area hardly causes any visual impairment and does not pose any risk of “vandalism” from the outside, since it is protected from access by unauthorized persons.

Another advantage is that at this position, access to the gap between the top of the high-voltage battery and the underside of the vehicle floor can be provided particularly easily and virtually infallibly. Here, for example, no guide element is required, as it will be explained in more detail later. If penetration of the extinguishing lance into the battery housing is to be prevented, the housing cover can simply be made correspondingly robust. Otherwise, if the extinguishing lance, which is guided through the vehicle floor, is also to penetrate the battery housing, the underlying battery housing cover can have a correspondingly thin-walled design or have an opening, predetermined breaking point or similar material weakening. The dead area is then provided in such a way that it opens out between two battery modules, for example, so that damage to battery cells can be ruled out.

In a further advantageous embodiment of the invention, the side wall is different from the vehicle floor, wherein the access area is arranged in a side sill area of a side sill of the motor vehicle, or in a wheel housing or wheel case, or in a connection area which directly adjoins the side sill area in the upward direction of the vehicle and is located below a vehicle door of the motor vehicle with respect to the upward direction of the vehicle. This advantageously allows the extinguishing lance to be inserted from the side. This has the great advantage that there does not necessarily have to be access to the vehicle interior in order to be able to insert the extinguishing lance. Particularly in the case of more serious accidents in which, for example, vehicle doors are deformed, there is not necessarily always access to the interior of the motor vehicle. It is also usually necessary to get close to the motor vehicle to gain access to the interior of the motor vehicle, which in turn poses additional risks to rescue personnel. The lateral feed capability of the extinguishing lance provided by the positioning of the access area in the side sill area or connection area allows the lance to be inserted from outside the motor vehicle, increasing the likelihood that such an access area will actually be accessible in the case of a motor vehicle involved in an accident and increasing safety for rescue personnel.

In a further advantageous embodiment of the invention, the access area is positioned in the side sill area or connection area or in the wheel housing or wheel cast and is designed in such a way that an extinguishing device, in particular an extinguishing lance, which passes at least partially through the access area, can be inserted into the receiving area in a guide direction which encloses a non-zero angle with a vehicle transverse axis, in particular an angle greater than 20 degrees. In other words, in this example the extinguishing lance is not inserted into the access area parallel to the transverse axis of the vehicle, but at an angle from the side, so that the guide direction in which the lance is inserted is precisely not parallel to the transverse axis of the vehicle, but encloses an angle, in particular greater than 20 degrees, preferably even greater. This has the advantage that the rescue personnel can, for example, also be located behind the rear of the vehicle or in front of the front of the vehicle and can insert the extinguishing lance at an angle into the receiving area, while at the same time creating a higher safety distance from the battery fire. Even if, for example, the battery fire is already very advanced, it is then still possible to insert the extinguishing lance from a safe distance and thus extinguish the battery fire. The ability to insert at an angle to the vehicle's transverse axis also advantageously allows the access area to be provided in a wheel housing or wheel cast. This can be a wheel housing for a front wheel and/or a wheel housing for a rear wheel of the motor vehicle. In this case, the access area is located in a wall of the wheel housing facing the receiving area. The fact that the wheels partially block the wheel housing means that it is still possible to pierce the wheel housing at a certain angle and thus reach the receiving area and, if necessary, the battery housing with the extinguishing device.

Nevertheless, it is also conceivable that the access area is positioned and designed in such a way that insertion of the one extinguishing device, in particular an extinguishing lance, is also possible parallel to the transverse direction or transverse axis of the vehicle, if necessary at an angle with respect to the horizontal, in particular if the access area is provided at a position different from the wheel housing.

In a further advantageous embodiment of the invention, the access area provides a passage opening with a guide element which is designed to guide an extinguishing device, in particular an extinguishing lance, inserted into the passage opening in a specific directional range. Such a guide element is particularly advantageous if the access area is not located in the vehicle floor but, for example, in the side sill area or in the wheel housing or connection area defined above. Such a design of the access area can advantageously ensure that the extinguishing lance is guided exclusively into the associated dead area, even if, for example, the entrance opening of the passage opening is designed so large that the extinguishing lance has at least initial play therein. On the one hand, this makes it particularly easy to insert the extinguishing lance, for example by providing a relatively large entrance opening, and on the other hand it allows the lance to be guided into a defined area in a targeted manner, which in turn reduces safety risks for rescue personnel.

It is particularly advantageous if the guide element tapers in the direction of the receiving area. This makes it particularly easy to provide guidance for the extinguishing lance. This conical inlet also allows a relatively large entrance opening to be provided on the side of the access area opposite the receiving area, making it much easier to insert the extinguishing lance. This is particularly advantageous if, in addition, visibility is restricted, for example, by smoke or flames. The guide element can, for example, be conical or frustoconical, pyramidal, tapered or have a similar tapering shape. Further, such a guide element may be formed by suitable geometric design of the passage opening in the side wall or the guide element may be provided by a specially manufactured component, such as a funnel, which is attached to a motor vehicle component providing the remaining side wall. In any case, it is preferred that such a guide element be made of refractory, high-melting material, such as steel.

In a further advantageous embodiment of the invention, the access area comprises a sealing element adapted to seal an extinguishing device, in particular an extinguishing lance, passed partially through the access area, with respect to the side wall. This has the great advantage that backflow of water can be largely avoided, which makes extinguishing the battery fire even more effective. To integrate the sealing element, there are again several possibilities. For example, such a sealing element may be provided by the guide element just described. For example, a guide element designed as a guide funnel can perform a sealing action together with the extinguishing lance. For example, a type of rubber sleeve or the like may be arranged at the tapered end of such a guide funnel. Such a seal can also be arranged on the insertion side. For example, such a seal may be formed together with a closure for the access area, as will be described in more detail later. Also, such a sealing effect can be executed via an engagement of the extinguishing lance with or at or in the access area, or other sealants and/or valves or the like. It may also be provided that the extinguishing lance can be irreversibly connected to the guide funnel or, in general, to the guide device, or reversibly connected via a mechanical locking function, such as a quick coupling with a bayonet lock or barb, together with the seal.

This is a particularly advantageous way of ensuring that the extinguishing lance can be held securely in position even after it has been inserted through the access area. In particular, this then no longer has to be held in position by rescue personnel, but can be held in the access area and locked in position by the locking function.

In another advantageous embodiment of the invention, the access area provides a passage opening that includes a closure configured as a sealing membrane or sleeve that can be pierced by an extinguishing lance. For example, such a closure may be provided as a type of rubber-elastic grommet. Such a grommet or membrane can be pierced very easily by an extinguishing lance and then simultaneously fulfills a sealing function. At the same time, such a membrane or grommet closes the passage opening when there is no emergency, i.e. during normal operation of the motor vehicle, and thus protects the access area against the ingress of dust, water or the like. Such a closure is particularly advantageous when the access area is located on the outside of the motor vehicle. Nevertheless, such a closure can also be designed differently. For example, a dimensionally stable plastic cap can also be provided as a closure, or a metal sheet closure, optionally with pre-notching and/or colored marking. This makes it easier for rescue personnel to find them. Such a metallic sheet is comparatively neutral in design. Therefore, the combination with a visual marking is advantageous, so that the firefighter knows at which point to pierce the extinguishing lance. Another particularly advantageous feature is the design of a closure in such a way that it does not have to be opened manually, but can simply be pierced with the extinguishing lance even from a distance. A close approach is not always possible in the event of a vehicle fire. Such a design of a closure thus advantageously also enables feeding of the extinguishing lance into the access area from a distance.

In another embodiment, an attachment for the extinguishing lance may also be provided that is mountable to the extinguishing end of the extinguishing lance to provide an extension. Such an attachment may also comprise a pipe, and a coupling piece adjoining the pipe and adapted to be coupled to the extinguishing end of the extinguishing lance. The extinguishing end of the lance represents the end of the lance from which water can escape. This has the great advantage that an extinguishing operation can be started by such an attachment from an even greater distance, which in turn brings more safety for rescue personnel and increases the probability of access. In addition, such an attachment may be made of temperature-resistant metal, such as steel. This means that the function of this attachment is not jeopardized even in the event of strong fire development.

The motor vehicle according to the invention is preferably designed as a motor vehicle, in particular as a passenger car or truck, or as a passenger bus or motorcycle.

The invention also includes combinations of the features of the described embodiments. Thus, the invention also includes implementations each having a combination of the features of more than one of the described embodiments, provided that the embodiments have not been described as mutually exclusive.

### BRIEF DESCRIPTION OF THE FIGURES

Examples of embodiments of the invention are described below. Showing for this purpose:

FIG. 1 a schematic cross-sectional view of a motor vehicle perpendicular to the longitudinal direction of the vehicle with an access area for an extinguishing lance, which is guided through the access area into an intermediate space between a high-voltage battery and the vehicle floor of the motor vehicle, according to an exemplary embodiment of the invention;

FIG. 2 a schematic cross-sectional view of a motor vehicle perpendicular to the transverse direction of the vehicle with an access area arranged in the vehicle floor for an extinguishing lance according to a further exemplary embodiment of the invention;

FIG. 3 a schematic cross-sectional view of a motor vehicle perpendicular to the transverse direction of the vehicle with an access area arranged in the vehicle floor for an extinguishing lance according to a further exemplary embodiment of the invention;

FIG. 4 a schematic cross-sectional view of a motor vehicle perpendicular to the transverse direction of the vehicle with a laterally arranged access area for an extinguishing lance with an exemplary embodiment of the invention;

FIG. 5 a schematic representation of a motor vehicle in a cross-section perpendicular to the transverse direction of the vehicle with a laterally arranged access area through which an extinguishing lance can be inserted into a battery housing, according to a further exemplary embodiment of the invention; and

FIG. 6 a schematic top view of a motor vehicle with a side access area as shown in FIG. 4 or FIG. 5.

### DETAILED DESCRIPTION

The embodiments explained below are preferred exemplary embodiments of the invention. In the exemplary embodiments, the described components of the embodiments each represent individual features of the invention that are to be considered independently of one another, and which also each independently further the invention. Therefore, the disclosure is intended to include combinations of the features of the embodiments other than those shown. Furthermore, the described embodiments can also be supplemented by further of the already described features of the invention.

In the figures, identical reference signs denote elements with identical functions.

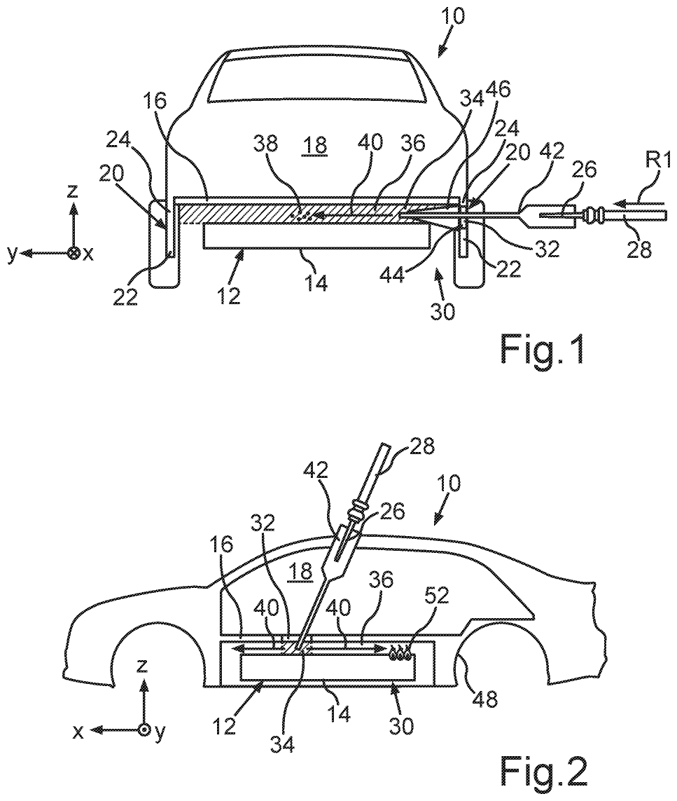

FIG. 1 shows a schematic representation of a motor vehicle 10, which has a high-voltage battery 12 comprising a battery housing 14 in which battery modules not shown in greater detail are arranged, which in turn may comprise a plurality of individual cells. Further, the high voltage battery 12 is disposed below a vehicle floor 16 which provides a lower boundary of a passenger interior 18. Furthermore, the motor vehicle has a right and left side area 20 viewed in the longitudinal direction of the vehicle, which corresponds to the x-direction shown, which in turn is divided into a sill area 22 and a connection area 24 directly adjacent to the sill area 22, which is arranged below the vehicle doors viewed in the upward direction of the vehicle, which corresponds to the z-direction shown. The sill area 22 thereby defines an area in which a side sill of the motor vehicle 10 with optional crash structures is arranged. The connection area directly adjoins this side sill area 22 in the upward direction of the vehicle and ends, for example, in the area of the vehicle doors, in particular below the vehicle floor 16. Accordingly, crash structures do not necessarily have to be arranged in the connection area.

In the event of a vehicle accident, the high-voltage battery 12 may be damaged, i.e. a burgeoning battery fire. To extinguish such a battery, firefighters typically use an extinguishing device, particularly an extinguishing lance 26 that can be connected to a fire hose 28. This is fed to a receiving area 30 in which the battery 12 is received. In order to facilitate access to this receiving area and, in particular, to make it as safe as possible, the motor vehicle 10 advantageously has an access area 32 which is positioned and designed in such a way that an extinguishing lance 26 passed through this access area 32 can be inserted exclusively into a dead area 34 in which no battery cells are arranged. These dead areas 34 are shown hatched in FIG. 1 to FIG. 5. In this first example, this dead area 34 is at least partially located in an intermediate space 36 between the high voltage battery 12 and the vehicle floor 16. In other words, the access area 32 is positioned and designed to guide the extinguishing lance 26 that passes through this access area 32 into this intermediate space 36. Thus, the access area 32 advantageously provides a device which is designed to accommodate an extinguishing device, in this case an extinguishing lance 26, in order to be able to flood the air gap 36 between the vehicle underbody or vehicle floor 16 and the high-voltage battery 12 in the event of an accident. Flooding is carried out with an extinguishing agent 38, such as water. The direction of propagation of the extinguishing agent 38 exiting the extinguishing lance 26 is illustrated by the arrow 40.

In this example, an intermediate piece 42 is further shown in the form of an attachment for the extinguishing lance 26. This intermediate piece 42 can be mounted on the extinguishing lance 26 and serves as an extension of the extinguishing lance 26. This advantageously makes it possible to start the extinguishing process from a greater distance. Additionally, the intermediate piece 42 may be made of temperature resistant metal, for example steel. This means that its function is not jeopardized even in the event of a strong fire development and, in addition, the functionality of the extinguishing lance 26 is also protected and guaranteed. Like the extinguishing lance 26, this intermediate piece 42 may be designed with a front tip to facilitate penetration of the access area 32. In the following, an extinguishing device shall be understood to include both the extinguishing lance 26 and the intermediate piece 42, as well as their combination.

Further, the access area 32 may be configured with a closure 44. This does not necessarily have to be designed for reversibly closing and opening the access area, but can also be designed in such a way that it can only irreversibly release the access area 32. For example, this closure 44 may be in the form of a rubber-elastic grommet and/or a dimensionally stable plastic cap, or it may be made of metal sheet, optionally with pre-notching and/or colored marking. The rubber-elastic grommet or membrane is easy to pierce and seals well against the car body, while the metal sheet is comparatively neutral in design but more difficult to pierce. It is then advantageous to provide a visually recognizable marking from the outside in the area of the access area 32, preferably on the closure 44, so that a firefighter knows at which point to pierce the extinguishing device, i.e. the extinguishing lance 26, or the attached extension, i.e. the intermediate piece 42.

In another advantageous embodiment, the access area further comprises a guide element, such as a guide funnel 46 in this example. This guide funnel can be arranged behind the closure 44 as viewed in the direction of the receiving area 30, so that the extinguishing lance 26 or the intermediate piece 42 can be guided directly into the air gap 36 in order to introduce extinguishing agent 38 there. This is so advantageous because it allows the vehicle floor 16 to be cooled, which is necessary to delay ignition of interior components. Additionally, this can also provide some cooling to the high voltage battery 12.

The guide funnel 46 can, for example, be designed as a cone or even pyramid-shaped. In any case, it is preferred that this points and tapers in the direction of the high-voltage battery 12 or the receiving area 30. The guide funnel 46 may further be made of refractory, high-melting material, such as steel. Due to its funnel shape, this guides the tip of the extinguishing device, i.e. the extinguishing lance 26 or the intermediate piece 42, specifically into the air gap 36. Optionally, the guide funnel may also perform an additional sealing action in conjunction with the extinguishing device 26, 42 to prevent backflow of water 38 to the greatest extent possible. This can be realized technically via an engagement, by means of sealants and/or valves. The extinguishing device 26, 42 can be irreversibly connected to the guide funnel 46 or reversibly connected via a mechanical locking form, for example a quick coupling with a bayonet lock or barb, optionally including a seal.

There are also various possibilities for the arrangement of the access area 32 with respect to its position. As described above, it is particularly advantageous to introduce cooling agent 38 into the intermediate space 36 between the battery 12 and the motor vehicle floor 16, primarily to be able to achieve a cooling effect of the motor vehicle floor 16. This can be realized as illustrated in FIG. 1 by providing the access area 32 in a side sill area 22 or the described connection area 24. Thus, the opening provided by the access area 32 may be provided in the side sill itself and/or may be carried out above the crash profile and/or through the crash structure or crash profile.

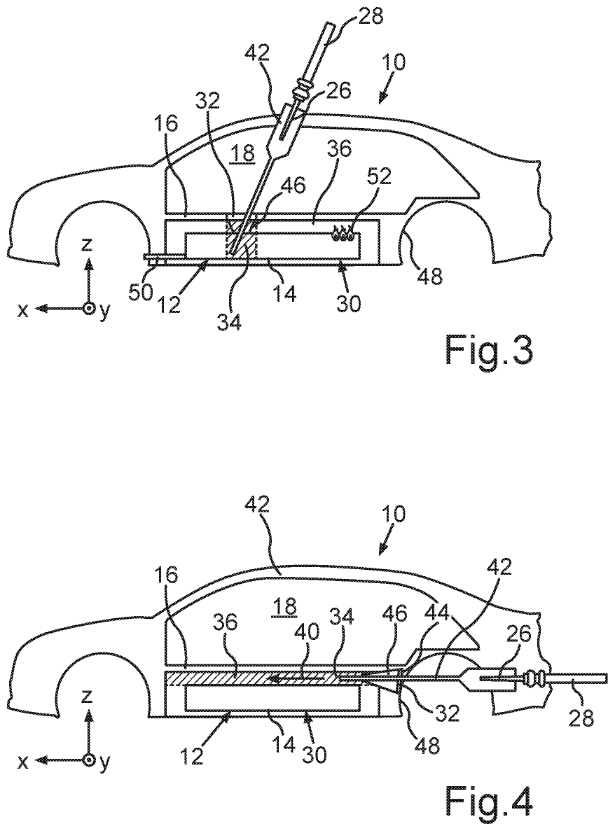

However, the access area can also be provided in the vehicle floor 16 itself, as shown schematically in FIG. 2. In addition, the motor vehicle 10, which is shown schematically in FIG. 2, can be designed as described for FIG. 1. The access area 32 is thus arranged here in the interior 18, for example under the carpet, in the vehicle floor 16, which has the advantage, for example, that there is hardly any visual impairment and no risk of “vandalism” from the outside. Furthermore, another advantage could be that in this embodiment, the optional guide funnel 46 can be omitted since the access area 32 is located immediately above the air gap 36. For example, if it is to be ensured that the tip of the extinguishing device 26, 42 does not penetrate further, i.e. does not pierce the battery housing 14, this can be provided in this example in a simple manner by a suitably robust design of a battery cover, which is the part of the battery housing 14 facing the vehicle floor 16. Alternatively, it may also be possible or desired to allow piercing of the battery housing 14, as illustrated in FIG. 3. Accordingly, in this example, a portion of the dead area 34 may also be provided within the battery housing 14. This therefore represents an area within the battery housing 14 in which no battery cells are also arranged, so that the extinguishing lance 26 can be inserted here without any concern. In this case, the additional provision of a guide funnel 46 through the access area 32 may again be advantageous, even if in this example the access area 32 is again arranged in the vehicle floor 16, since by means of such a guide funnel 46 the extinguishing lance 26 can be guided safely and specifically into the dead area 34. The ability to insert the extinguishing device 26, 42 directly into the battery 12 allows the battery housing 14 to be flooded. This allows for very good extinguishing of the fire, especially much better than just washing around the outside of the battery 12.

Furthermore, in this case in which the extinguishing device 26, 42 is to be inserted into the interior of the battery housing 14, a weakening of the material of the battery housing 14 can be provided at the appropriate location if the battery housing 14 is not in any case sufficiently thin in these areas to permit easy piercing with an extinguishing lance 26 or an intermediate piece 42. Furthermore, in this example, in which the extinguishing lance 26 or the intermediate piece 42 is to be inserted into the interior of the battery housing 14 in order to flood the latter, it is further particularly advantageous if the high-voltage battery 12 has also an outlet 50 via which the extinguishing agent 38 can leave the battery housing 14 again. Such an outlet 50 can be used to set specific flow conditions within the battery housing 14 and, in addition, the extinguishing agent flow rate through the battery housing 14 can also be increased, thereby increasing the cooling effect. This outlet 50 thus provides a fluidic connection between the interior of the battery and the environment. This outlet 50 may further be provided with a safeguard to protect access from the outside, such as a relief valve or the like.

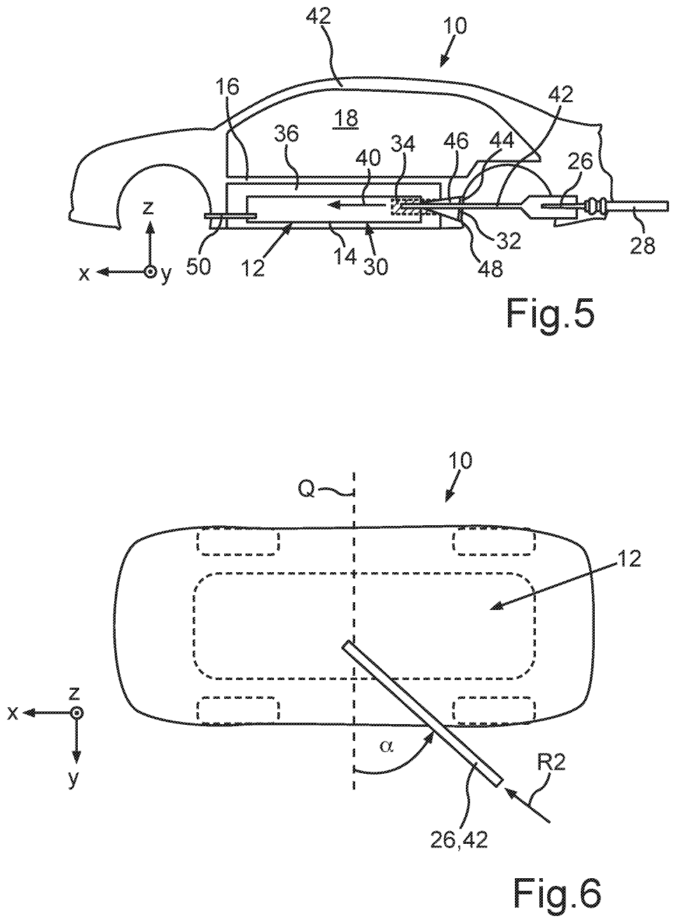

Accessibility to the interior 18 is basically only possible if the battery fire is not yet so far advanced. Accordingly, it is advantageous if at least one access area is not provided in the vehicle floor 16, but at another location on the motor vehicle 10 that is adjacent to the receiving area 30. One such location may be the side area 20 already described with respect to FIG. 1. In FIG. 1, the extinguishing lance 26 is guided in a guide direction R1, which is parallel to the transverse direction of the vehicle (see FIG. 6), which is oriented in the y-direction shown. The vehicle's transverse direction is parallel to the vehicle's transverse axis Q (see FIG. 6). However, it is also particularly advantageous if the access area 32 is designed in such a way that the extinguishing device 26, 42 can be inserted into the receiving area 30 at an angle to this transverse vehicle axis Q, which is illustrated in FIG. 4, FIG. 5 and in a top view in FIG. 6. This can in turn be accomplished by suitable positioning of the access area in the side area 20, as well as, for example, by forming it with a suitable guide element such as the guide funnel 46. FIG. 4 schematically shows the motor vehicle in a cross-sectional view perpendicular to the vehicle transverse axis Q, in which the access area 32 is designed in such a way that the extinguishing lance 26 introduced through it is in turn introduced into the intermediate space 36 between the battery 12 and the vehicle floor 16, while FIG. 5 schematically shows the variant according to which the access area 32 is positioned and designed in such a way that the extinguishing lance 26 is introduced specifically into the inner area of the battery housing 14. In both cases, this is done at an angle from the side, i.e. at an angle α, to the vehicle's transverse axis Q, which is illustrated in FIG. 6 in a plan view of the motor vehicle 10. R2 here denotes the guiding direction in which the extinguishing lance 26 is guided through the access area 32. This direction is dictated by the funnel 46 after insertion into the access area 32. In addition, the extinguishing device 26, 42 is guided through the access area 32, which in these examples in FIG. 4 and FIG. 5 is arranged in the wheel housing 48 or in the wheel cast 48 of the motor vehicle 10, in particular in a rear wheel cast 48.

Lateral piercing at an angle α has the great advantage that a higher safety distance of the firefighters to the battery fire 52 can be set. In addition, this allows the access area 32 to be provided in a wheel housing 48 or wheel cast 48 of the motor vehicle 10.

Although this is also not shown, the access area 32 may also be located anywhere else on the motor vehicle 10, such as in the trunk, engine compartment, front of vehicle area, rear area, and so forth. It is also advantageous if, for example, several such access areas are provided at different positions of the motor vehicle 10. This would have the great advantage that in the event of a vehicle fire 52, there would be multiple opportunities to introduce the extinguishing device 26, 42.

Overall, the examples show how the invention can provide a battery extinguishing option with optimized accessibility that effectively increases the recovery time by firefighters because a cooling function can be performed by the vehicle floor and the high-voltage battery. In addition, increased safety for firefighters and bystanders and infrastructure can be provided. Moreover, this can be realized with only a very small intervention in the vehicle structure, which means only minor additional costs. Special qualifications by the firefighters are also not necessary due to the increased safety provided by the invention. In addition, these embodiments hold high potential for cross-industry standardization and provide very simple operation.

1. A motor vehicle with an access area for extinguishing a battery fire, comprising:
a high-voltage battery, which has a battery housing and at least one battery module arranged in the battery housing with at least one battery cell,
a receiving area in which the high-voltage battery is received,
a side wall, which bounds the receiving area in at least one direction,
the access area, which is positioned in the side wall and which is configured such that an extinguishing device can be inserted from a side of the side wall facing away from the high-voltage battery through the access area at least partially into the receiving area;
wherein
the receiving area has at least one defined dead area associated with the access area and free of battery cells, wherein the at least one battery cell is arranged in a region of the receiving area which is different from the dead area, wherein the access area is positioned and designed in such a way that an extinguishing device which passes at least partially through the access area can be inserted exclusively into the associated dead area.

2. The motor vehicle according to claim 1, wherein the motor vehicle has a motor vehicle floor adjacent to the receiving area, wherein the high-voltage battery is arranged below the motor vehicle floor and at a distance from the motor vehicle floor, so that there is an intermediate space between the high-voltage battery and the vehicle floor.

3. The motor vehicle according to claim 2, wherein the access area is positioned and configured such that an extinguishing device passing at least partially through the access area opens into the intermediate space, wherein the dead area is arranged completely outside the battery housing.

4. The motor vehicle according to claim 1, wherein the dead area is arranged at least partially within the battery housing.

5. The motor vehicle according to claim 2, wherein the side wall constitutes at least part of the vehicle floor of the motor vehicle or the side wall is different from the vehicle floor, wherein the access area is then arranged in a side sill area of a side sill of the motor vehicle or in a wheel housing or in a connection area, which directly adjoins the side sill area in the upward direction (z) of the vehicle and is located below a vehicle door of the motor vehicle with respect to the upward direction (z) of the vehicle.

6. The motor vehicle according to claim 5, wherein the access area is positioned in the side sill area or connection area or in the wheel housing and is designed in such a way that an extinguishing device which passes at least partially through the access area can be introduced into the receiving area in a guide direction (R2) which includes a non-zero angle (a) with a vehicle transverse axis (Q), in particular an angle (α) greater than 20°.

7. The motor vehicle according to claim 1, wherein the access area provides a passage opening with a guide element adapted to guide an extinguishing device inserted into the passage opening in a predetermined directional range.

8. The motor vehicle according to claim 7, wherein the guide element tapers in the direction of the receiving area.

9. The motor vehicle according to claim 1, wherein the access area includes a sealing element adapted to seal an extinguishing device passing partially through the access area with respect to the sidewall.

10. The motor vehicle according to claim 1, wherein the access area provides a passage opening which has a closure formed as a sealing membrane or sleeve that can be pierced by an extinguishing device.

11. The motor vehicle according to claim 2, wherein the dead area is arranged at least partially within the battery housing.

12. The motor vehicle according to claim 3, wherein the dead area is arranged at least partially within the battery housing.

13. The motor vehicle according to claim 3, wherein the side wall constitutes at least part of the vehicle floor of the motor vehicle or the side wall is different from the vehicle floor, wherein the access area is then arranged in a side sill area of a side sill of the motor vehicle or in a wheel housing or in a connection area, which directly adjoins the side sill area in the upward direction (z) of the vehicle and is located below a vehicle door of the motor vehicle with respect to the upward direction (z) of the vehicle.

14. The motor vehicle according to claim 4, wherein the side wall constitutes at least part of the vehicle floor of the motor vehicle or the side wall is different from the vehicle floor, wherein the access area is then arranged in a side sill area of a side sill of the motor vehicle or in a wheel housing or in a connection area, which directly adjoins the side sill area in the upward direction (z) of the vehicle and is located below a vehicle door of the motor vehicle with respect to the upward direction (z) of the vehicle.

15. The motor vehicle according to claim 2, wherein the access area provides a passage opening with a guide element adapted to guide an extinguishing device inserted into the passage opening in a predetermined directional range.

16. The motor vehicle according to claim 3, wherein the access area provides a passage opening with a guide element adapted to guide an extinguishing device inserted into the passage opening in a predetermined directional range.

17. The motor vehicle according to claim 4, wherein the access area provides a passage opening with a guide element adapted to guide an extinguishing device inserted into the passage opening in a predetermined directional range.

18. The motor vehicle according to claim 5, wherein the access area provides a passage opening with a guide element adapted to guide an extinguishing device inserted into the passage opening in a predetermined directional range.

19. The motor vehicle according to claim 6, wherein the access area provides a passage opening with a guide element adapted to guide an extinguishing device inserted into the passage opening in a predetermined directional range.

20. The motor vehicle according to claim 1, wherein the access area includes a sealing element adapted to seal an extinguishing device passing partially through the access area with respect to the sidewall.
